(19) United States
(12) Patent Application Publication
(10) Pub. No.: US 2026/0134360 A1
(43) Pub. Date: May 14, 2026

(54) MACHINE LEARNING-BASED RECOMMENDATION SYSTEM WITH DATA STRUCTURE PROCESSING

(71) Applicant: Dell Products L.P., Round Rock, TX (US)

(72) Inventors: Mohit Kumar Agarwal, Cyberjaya (MY); Bijan Kumar Mohanty, Austin, TX (US); Manoj Nambirajan, Hyderabad (IN); Hung T. Dinh, Austin, TX (US)

(21) Appl. No.: 18/945,097

(22) Filed: Nov. 12, 2024

(51) Int. Cl. G06Q 10/0631

(52) U.S. Cl. CPC G06Q 10/063112

(57) ABSTRACT

Methods, apparatus, and processor-readable storage media for implementing a machine learning-based recommendation system with data structure processing are provided herein. An example computer-implemented method includes processing, into one or more data structures comprising resource-related task allocation data, information pertaining to at least one resource-related task request for at least one given user; generating filtered data by processing at least a portion of the one or more data structures using one or more machine learning-based filtering techniques; generating at least one system recommendation for allocating the at least one resource-related task request by processing at least a portion of the filtered data; and performing one or more automated actions based at least in part on the at least one generated system recommendation.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many enterprises and other organizations seek to allocate or distribute resource-related tasks to various users and/or systems for processing or action. Such users and/or systems may encompass particular skills and/or abilities relevant to the corresponding resource-related tasks. However, conventional resource management approaches often include static searches of users and/or systems based on limited and/or outdated information, which can result in time-intensive processes which produce sub-optimal or inaccurate selections as well as related resource wastage.

### SUMMARY

Illustrative embodiments of the disclosure provide machine learning-based recommendation systems with data structure processing.

An exemplary computer-implemented method includes processing, into one or more data structures comprising resource-related task allocation data, information pertaining to at least one resource-related task request for at least one given user. Additionally, the method includes generating filtered data by processing at least a portion of the one or more data structures using one or more machine learning-based filtering techniques, and generating at least one system recommendation for allocating the at least one resource-related task request by processing at least a portion of the filtered data. Further, the method also includes performing one or more automated actions based at least in part on the at least one generated system recommendation.

Illustrative embodiments can provide significant advantages relative to conventional resource management approaches. For example, problems associated with time-intensive processes which produce sub-optimal or inaccurate user and/or system selections as well as related resource wastage are overcome in one or more embodiments through automatically generating resource-related task allocation recommendations using machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing a machine learning-based recommendation system with data structure processing in an illustrative embodiment.

FIG. 2 shows example pseudocode for implementing one or more preprocessing actions in an illustrative embodiment.

FIG. 3 shows example pseudocode for generating an interaction matrix in an illustrative embodiment.

FIG. 4 shows example pseudocode for splitting training and testing data in an illustrative embodiment.

FIG. 5 shows example pseudocode for performing matrix factorization in an illustrative embodiment.

FIG. 6 shows example pseudocode for reconstructing an interaction matrix in an illustrative embodiment.

FIG. 7 shows example pseudocode for generating a partner recommendation function in an illustrative embodiment.

FIG. 8 shows example pseudocode for generating partner recommendation function outputs in an illustrative embodiment.

FIG. 9 is a flow diagram of a process for implementing a machine learning-based recommendation system with data structure processing in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

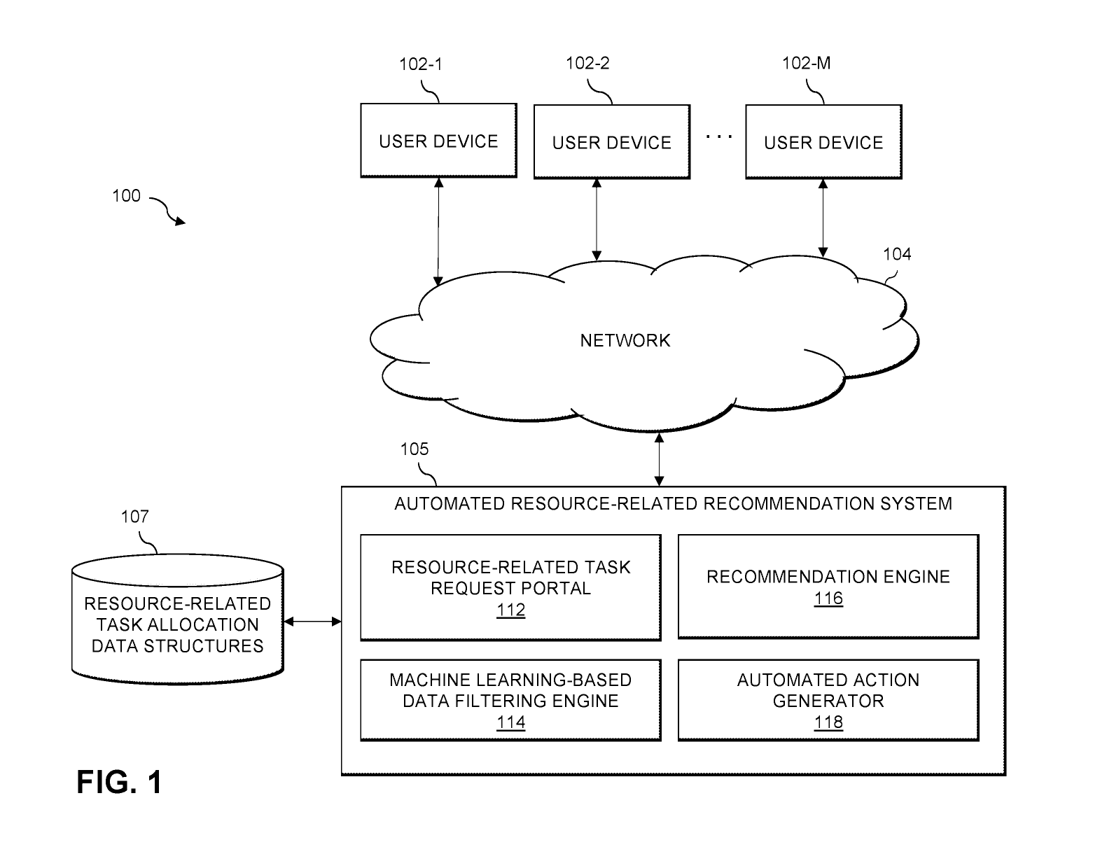

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated resource-related recommendation system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated resource-related recommendation system 105 can have one or more resource-related task allocation data structures 107 configured to store data pertaining to resource-related task request data associated with various users (e.g., user data, resource data, request data, etc.) and resource-related task request allocation data associated with various systems and/or users (e.g., system data, system performance metrics, etc.). The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The resource-related task allocation data structures 107 in the present embodiment are implemented using one or more storage systems associated with the automated resource-related recommendation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated resource-related recommendation system 105 are one or more input-output devices, which illustratively comprise keyboards, displays or other types of input-output devices in any combination. Such input-output devices can be used, for example, to support one or more user interfaces to the automated resource-related recommendation system 105, as well as to support communication between the automated resource-related recommendation system 105 and other related systems and devices not explicitly shown.

Additionally, the automated resource-related recommendation system 105 in the FIG. 1 embodiment is assumed to be implemented using at least one processing device. Each such processing device generally comprises at least one processor and an associated memory, and implements one or more functional modules for controlling certain features of the automated resource-related recommendation system 105.

More particularly, the automated resource-related recommendation system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated resource-related recommendation system 105 to communicate over the network 104 with the user devices 102, and illustratively comprises one or more conventional transceivers.

The automated resource-related recommendation system 105 further comprises a resource-related task request portal 112, a machine learning-based data filtering engine 114, a recommendation engine 116, and an automated action generator 118.

In one or more embodiments, and as further detailed herein, resource-related task request portal 112 can include at least one online and/or at least one offline sub-system for processing task requests from user devices 102. Additionally, machine learning-based data filtering engine 114 can filter at least a portion of the data processed via resource-related task request portal 112 using collaborative filtering techniques and/or content-based filtering techniques. Further, recommendation engine 116 can generate recommendations for one or more systems to allocate resource-related task requests processed through resource-related task request portal 112 by processing filtered data generated by machine learning-based data filtering engine 114. Also, automated action generator 118 can perform and/or initiate one or more automated actions based at least in part on the recommendations generated by recommendation engine 116.

It is to be appreciated that this particular arrangement of elements 112, 114, 116 and 118 illustrated in the automated resource-related recommendation system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for implementing a machine learning-based resource recommendation system with data structure processing involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated resource-related recommendation system 105, resource-related task allocation data structures 107, and user devices 102 can be on and/or part of the same processing platform.

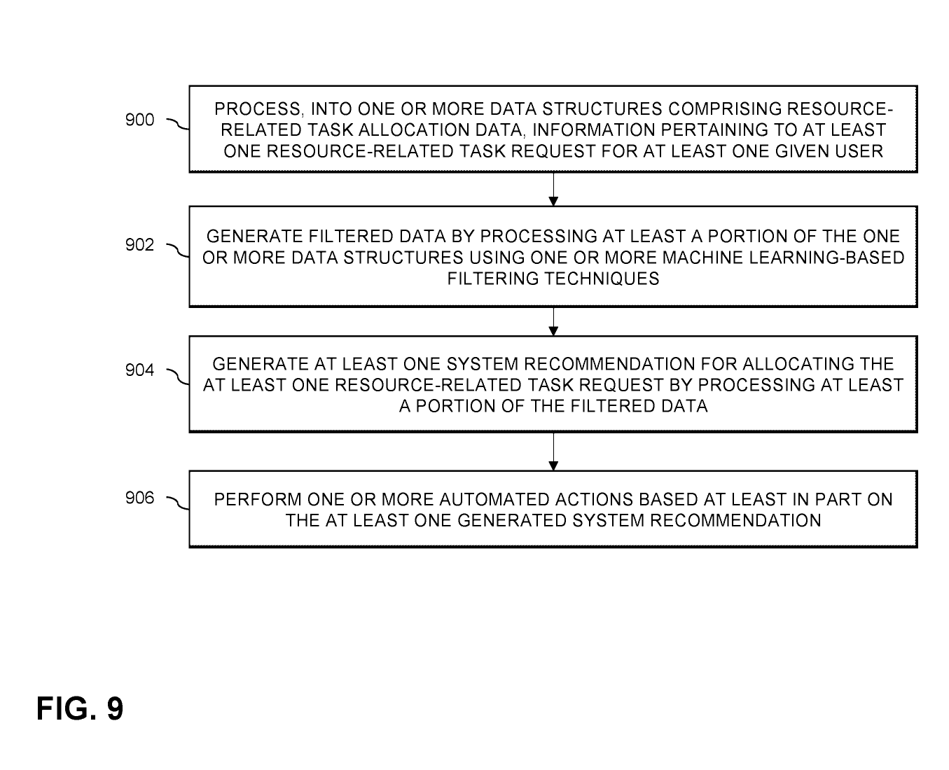

An exemplary process utilizing elements 112, 114, 116 and 118 of an example automated resource-related recommendation system 105 in computer network 100 will be described in more detail with reference to the flow diagram of FIG. 9.

Accordingly, at least one embodiment includes automatically generating resource-related task allocation recommendations using machine learning techniques. Such an embodiment includes leveraging one or more machine learning algorithms, trained on historical performance data of users and/or systems with respect to resource-related tasks, to enhance the user and/or system selection process. By analyzing historical performance-related metrics as well as feedback data pertaining to users and/or systems that performed relevant resource-related tasks (e.g., similar tasks involving similar resources, involving similar geographic parameters, etc.), at least one embodiment includes generating and/or implementing one or more machine learning-based predictive models that can identify the most effective user(s) and/or system(s) for one or more particularly resource-related tasks.

Accordingly, such an embodiment can include intelligently predicting and/or recommending one or more channel partners for at least one enterprise resource (e.g., one or more enterprise products and/or services) based at least in part on a variety of multi-dimensional features. Moreover, such an embodiment can include implementing a hybrid approach that combines content-based filtering and collaborative filtering to generate the prediction(s) and/or recommendation(s) with enhanced accuracy. The algorithms used in such a hybrid approach can include, for example, cosine similarity and/or attribute matching for content-based filtering, and matrix factorization for collaborative filtering. By combining these multiple types of algorithms, one or more embodiments include predicting and/or recommending a more accurate collection of channel partners.

As further detailed herein, such machine learning-based predictive models can assess various factors, such as, for example, task-related success rates, user satisfaction scores, geographic-related expertise, etc., to provide a ranked list of users and/or systems customized for one or more task-related needs and/or user-related needs. By continuously learning from new data, such machine learning-based predictive models can adapt to changing conditions and user and/or system capabilities, ensuring that accurate recommendations are dynamically generated for each task-related input and/or query.

In at least one embodiment, the one or more machine learning-based predictive models employ matrix factorization, a technique used in collaborative filtering, to analyze interactions between users and/or systems. Further, historical user and/or system selection data can include information including, e.g., product category, location and/or region, industry, end-user type, user/system qualifications and/or competencies, outcome of the engagement, etc. Such data can be used to train at least a portion of the one or more machine learning-based predictive models.

Also, as further detailed herein, at least one embodiment can include building and/or configuring at least one recommendation engine in conjunction with one or more machine learning-based predictive models. Building and/or configuring such a recommendation engine can include utilizing outputs generated using one or more content-based filtering techniques, one or more collaborative filtering techniques, or a hybrid approach that uses both content-based and collaborative filtering techniques.

Collaborative filtering techniques can be used to predict one or more preferences of at least one end-user based at least in part on the preferences of one or more other end-users. More particularly, collaborative filtering focuses on analyzing interactions between users (e.g., customers) and items (e.g., users and/or systems acting as partners on a given resource-related task) to identify one or more patterns. By leveraging historical interaction data, one or more embodiments utilizing collaborative filtering can include predicting future interactions based on past behavior. In such an embodiment, matrix factorization is used to decompose at least one interaction matrix and identify one or more latent factors that represent one or more underlying relationships between users (e.g., customers) and items (e.g., users and/or systems acting as partners on a given resource-related task). This facilitates and/or enhances the model’s ability to accurately recommend one or more partners who have been successful with similar customers in one or more historically relevant instances.

Additionally or alternatively, content-based filtering techniques utilize the attributes of users (e.g., customers) and items (e.g., users and/or systems acting as partners on a given resource-related task) to make one or more recommendations. In at least one embodiment, the one or more machine learning-based predictive models can consider various attributes of the partners (e.g., location, partner type, industry, product category, qualification competencies, tier, etc.) and customers (e.g., customer type, location, preferences, etc.) to filter and refine the recommendations. In such an embodiment, for example, the one or more machine learning-based predictive models can be trained, in conjunction with the content-based filtering techniques, to ensure that only partners who meet specific criteria (e.g., being in the same state and having a similar customer type) are considered for a recommendation for a given customer.

Further, in one or more embodiments, a hybrid recommendation generation approach includes combining collaborative filtering techniques with content-based filtering techniques to provide accurate recommendations on partners to customers or other end-users. Such a hybrid approach involves using similarities between end-users (determined, for example, using collaborative filtering) and similarities between partner features (determined, for example, using content-based filtering) to recommend the most relevant partners for a given end-user in connection with a resource-related task.

As noted, in at least one embodiment, collaborative filtering with matrix factorization includes analyzing historical interaction data to identify one or more patterns and predict one or more potential future interactions. Such an embodiment includes using truncated singular value decomposition (SVD) to decompose at least one interaction matrix into latent factors, allowing the algorithm to estimate the success likelihood of partner assignments.

Additionally, in one or more embodiments, content-based filtering can include attribute matching. Such an embodiment includes applying one or more filters based at least in part on one or more task-specific attributes to ensure that the recommendations are contextually appropriate. By way merely of example, such a filter can include considering only partners that have successfully made deals with customers of the same type and in the same geographic region. This can ensure that the recommendations are not only based on historical success but also on relevant attributes that increase the likelihood of future success. Further, the attributes can be changed and/or modified to include and/or exclude more attributes, as per the need(s) of the task-related request or instance.

As such, in one or more embodiments which include combining the approaches, the recommendation system can benefit from the strengths of both collaborative filtering and content-based filtering. More particularly, collaborative filtering leverages the collective intelligence of historical interactions, while content-based filtering ensures that the recommendations are tailored to specific attributes and/or needs of the end-user(s) and/or task(s) in question.

In connection with at least one embodiment which includes utilizing collaborative filtering with matrix factorization, a recommendation process includes construction of an interaction matrix, wherein, for example, rows represent end-users and columns represent partners (e.g., users and/or systems). In such an example embodiment, each cell in the matrix indicates whether a deal was made between a specific end-user-partner pair, and the matrix encapsulates historical performance data, serving as a foundation for the recommendation process. The matrix is also subjected to matrix factorization (e.g., truncated SVD), to decompose the matrix into two or more lower-dimensional matrices that capture underlying patterns and/or relationships within the data.

By way of illustration, matrix factorization can include decomposing the original interaction matrix into, for example, two lower-dimensional matrices: the end-user matrix (e.g., encompassing customer factors) and the item matrix (e.g., encompassing partner factors). In this example, each row in the end-user matrix represents a customer, characterized by one or more latent factors that capture one or more customer preferences. Similarly, in this example, each row in the item matrix represents a partner, characterized by one or more latent factors that capture one or more partner attributes and one or more indications of partner effectiveness.

The decomposition process can include solving for at least a portion of the one or more latent factors such that the product of the user matrix and the item matrix approximates the original interaction matrix. This approximation enables the algorithm to predict the likelihood of future interactions between one or more of the customers and one or more of the partners. By reconstructing the interaction matrix using the one or more latent factors, at least one embodiment can include estimating the potential success of assigning one or more specific partners to one or more specific customers to maximize the likelihood success of such interactions.

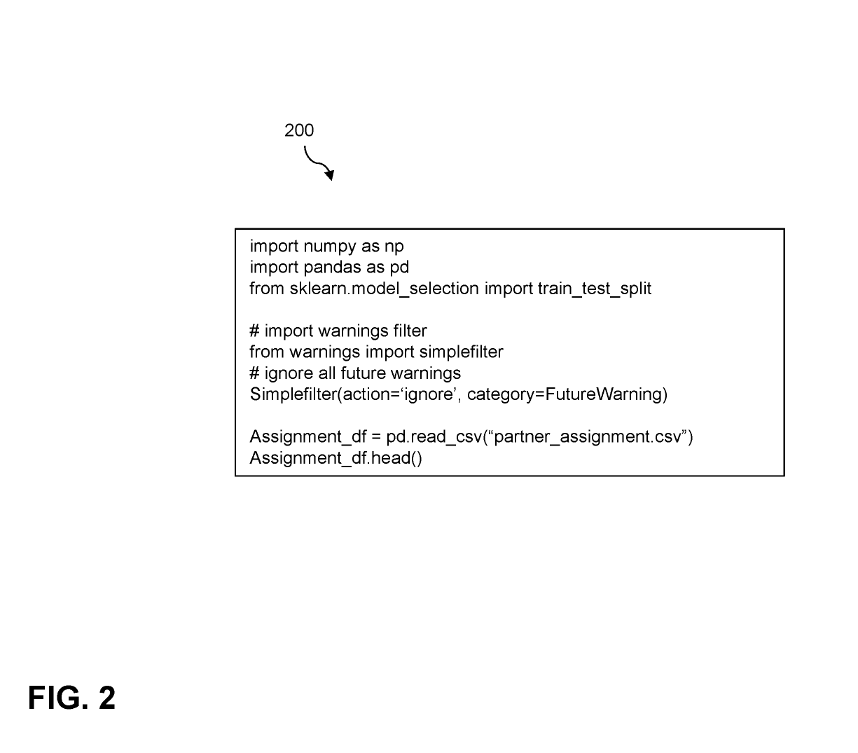

In one or more embodiments, at least one machine learning-based model can be implemented using Python, ScikitLearn, Pandas, and Numpy elements, such as detailed in connection with the example pseudocode depicted in FIG. 2 through FIG. 8.

FIG. 2 shows example pseudocode for implementing one or more preprocessing actions in an illustrative embodiment. In this embodiment, example pseudocode 200 is executed by or under the control of at least one processing system and/or device. For example, the example pseudocode 200 may be viewed as comprising a portion of a software implementation of at least part of automated resource-related recommendation system 105 of the FIG. 1 embodiment.

The example pseudocode 200 illustrates importing one or more required libraries, reading a user-partner assignment data file, and creating a Pandas dataframe.

It is to be appreciated that this particular example pseudocode shows just one example implementation of one or more preprocessing actions, and alternative implementations can be used in other embodiments.

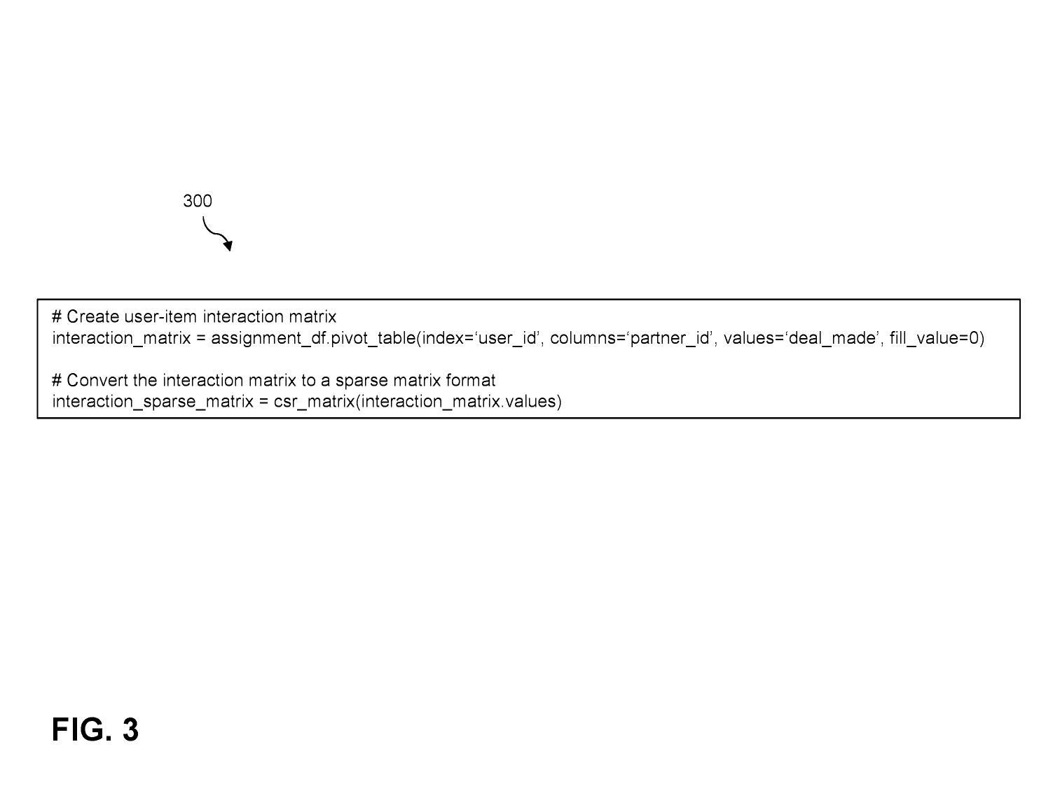

FIG. 3 shows example pseudocode for generating an interaction matrix in an illustrative embodiment. In this embodiment, example pseudocode 300 is executed by or under the control of at least one processing system and/or device. For example, the example pseudocode 300 may be viewed as comprising a portion of a software implementation of at least part of automated resource-related recommendation system 105 of the FIG. 1 embodiment.

The example pseudocode 300 illustrates creating an interaction matrix that will capture data pertaining to one or more deals and/or transactions made between users (e.g., customers) and partners. This interaction matrix is then converted into a sparse matrix format for efficient storage and use in one or more computations.

It is to be appreciated that this particular example pseudocode shows just one example implementation of generating an interaction matrix, and alternative implementations can be used in other embodiments.

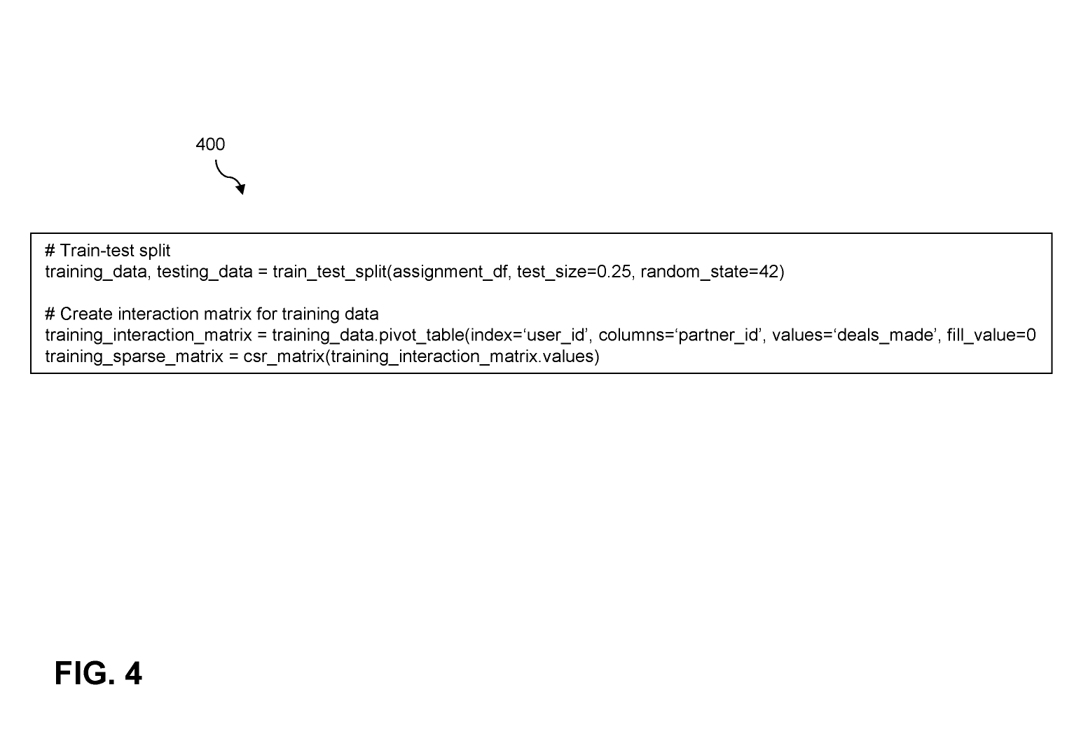

FIG. 4 shows example pseudocode for splitting training and testing data in an illustrative embodiment. In this embodiment, example pseudocode 400 is executed by or under the control of at least one processing system and/or device. For example, the example pseudocode 400 may be viewed as comprising a portion of a software implementation of at least part of automated resource-related recommendation system 105 of the FIG. 1 embodiment.

The example pseudocode 400 illustrates splitting the initial data into at least one training dataset and at least one testing dataset for validation. Additionally, as detailed in the example pseudocode 400, a sparse interaction matrix is created for the training data.

It is to be appreciated that this particular example pseudocode shows just one example implementation of splitting training and testing data, and alternative implementations can be used in other embodiments.

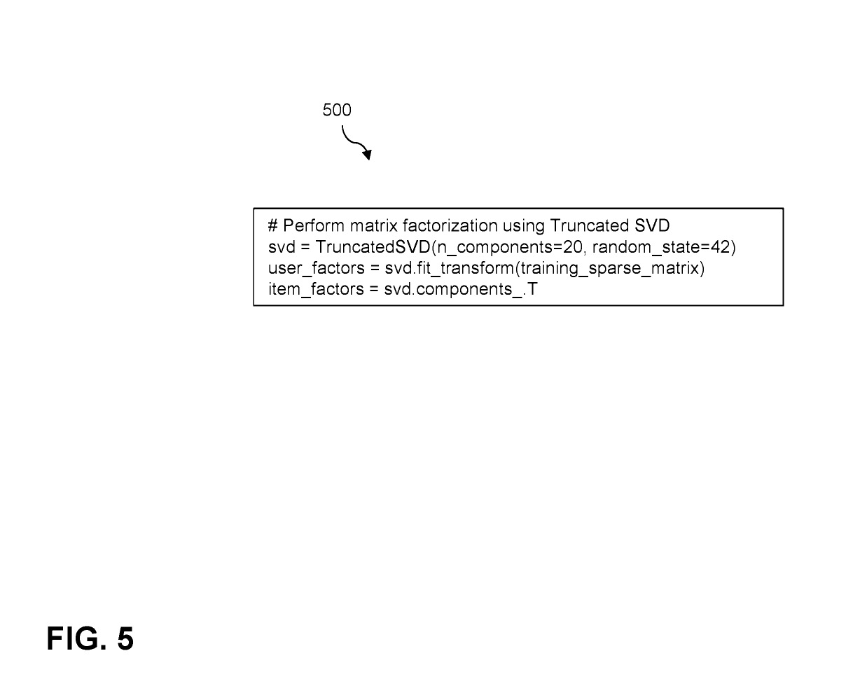

FIG. 5 shows example pseudocode for performing matrix factorization in an illustrative embodiment. In this embodiment, example pseudocode 500 is executed by or under the control of at least one processing system and/or device. For example, the example pseudocode 500 may be viewed as comprising a portion of a software implementation of at least part of automated resource-related recommendation system 105 of the FIG. 1 embodiment.

The example pseudocode 500 illustrates performing matrix factorization on the training interaction matrix using truncated SVD to derive one or more latent factors representing users (e.g., customers) and partners.

It is to be appreciated that this particular example pseudocode shows just one example implementation of performing matrix factorization, and alternative implementations can be used in other embodiments.

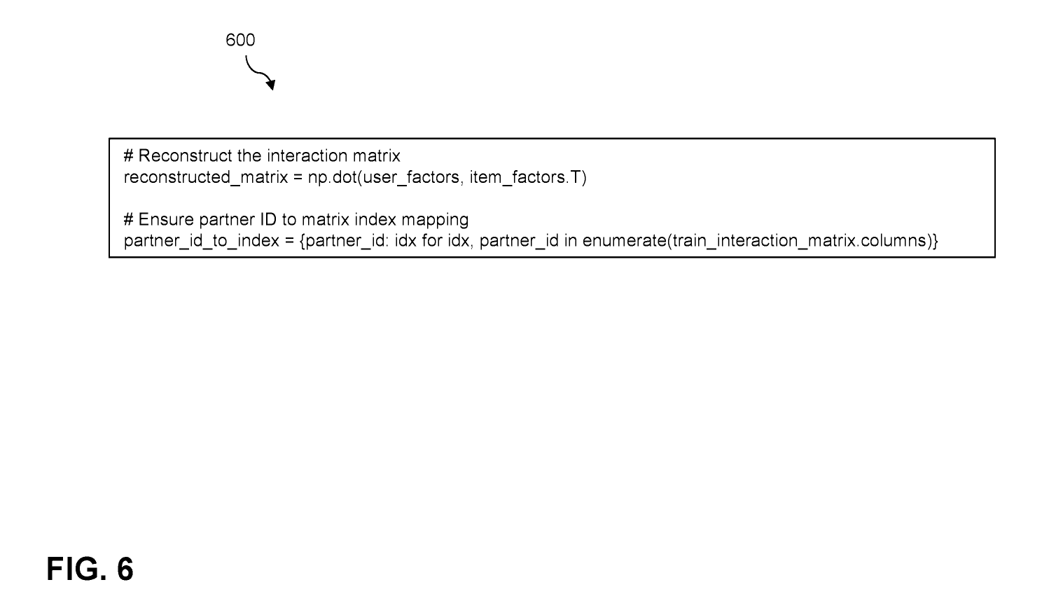

FIG. 6 shows example pseudocode for reconstructing an interaction matrix in an illustrative embodiment. In this embodiment, example pseudocode 600 is executed by or under the control of at least one processing system and/or device. For example, the example pseudocode 600 may be viewed as comprising a portion of a software implementation of at least part of automated resource-related recommendation system 105 of the FIG. 1 embodiment.

The example pseudocode 600 illustrates reconstructing the interaction matrix using the one or more latent factors to approximate one or more potential deals and/or transactions made by a given partner in the future. Further, as also depicted by example pseudocode 600, partner identifiers (IDs) are mapped to their respective matrix indices to facilitate access during predictions.

It is to be appreciated that this particular example pseudocode shows just one example implementation of reconstructing an interaction matrix, and alternative implementations can be used in other embodiments.

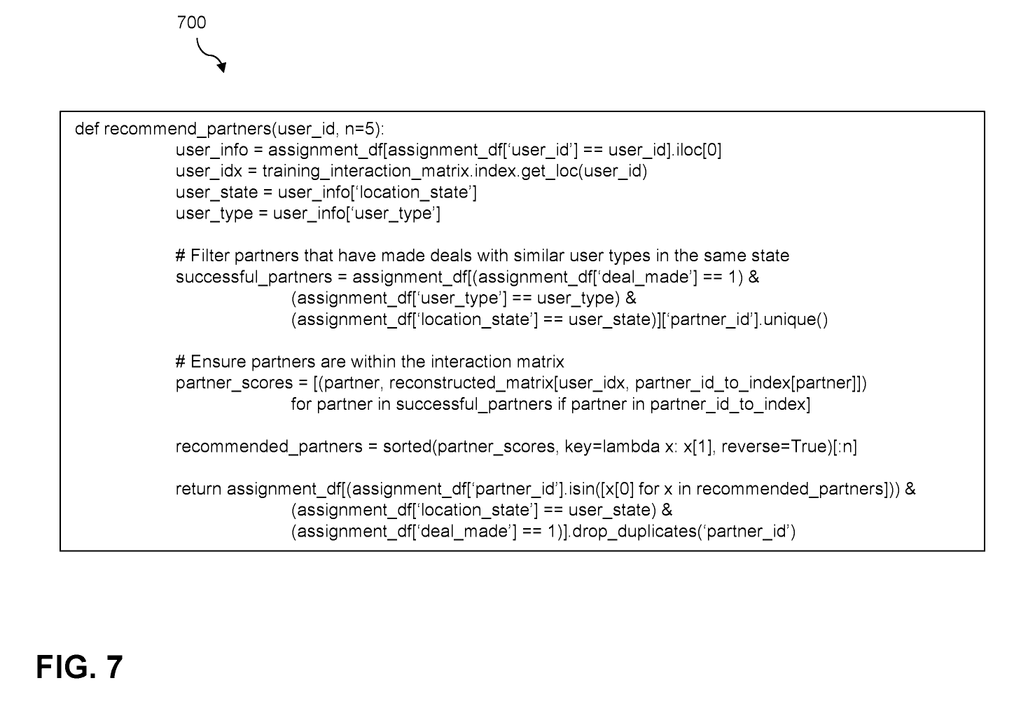

FIG. 7 shows example pseudocode for generating a partner recommendation function in an illustrative embodiment. In this embodiment, example pseudocode 700 is executed by or under the control of at least one processing system and/or device. For example, the example pseudocode 700 may be viewed as comprising a portion of a software implementation of at least part of automated resource-related recommendation system 105 of the FIG. 1 embodiment.

The example pseudocode 700 illustrates building the partner recommendation function, which will recommend the top N (e.g., the top five) partners for a given user (e.g., customer) based at least in part on historical deal data. Example pseudocode 700 includes retrieving the user’s state and type information, then filtering one or more partners that have successfully made deals with similar users in the same state. Additionally, as detailed in example pseudocode 600, the partner recommendation function computes scores for these partners using the reconstructed interaction matrix derived from matrix factorization. The partner recommendation function then sorts the partners by their scores, selects the top N, and returns the corresponding partner details from the assignment dataframe, ensuring that the partners are from the same state as the user and have previously made successful deals.

It is to be appreciated that this particular example pseudocode shows just one example implementation of generating a partner recommendation function, and alternative implementations can be used in other embodiments.

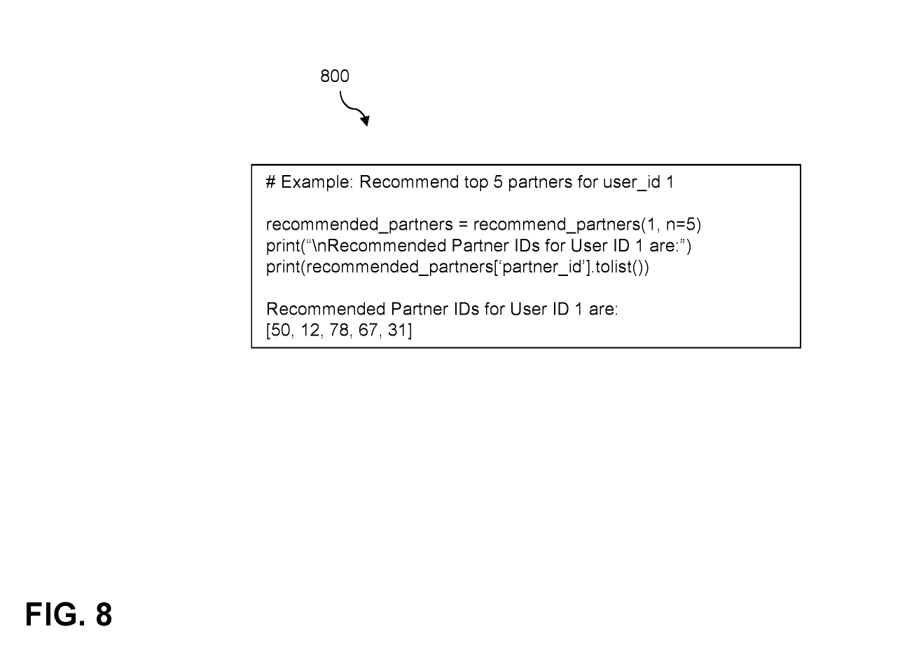

FIG. 8 shows example pseudocode for generating partner recommendation function outputs in an illustrative embodiment. In this embodiment, example pseudocode 800 is executed by or under the control of at least one processing system and/or device. For example, the example pseudocode 800 may be viewed as comprising a portion of a software implementation of at least part of automated resource-related recommendation system 105 of the FIG. 1 embodiment.

The example pseudocode 800 illustrates an example output of the partner recommendation function called for a user with a user ID of 1, wherein the resulting recommended partners (e.g., with the output being in the amount of a configurable value of five) are returned as partner IDs 50, 12, 78, 67 and 31.

It is to be appreciated that this particular example pseudocode shows just one example implementation of generating partner recommendation function outputs, and alternative implementations can be used in other embodiments.

FIG. 9 is a flow diagram of a process for implementing a machine learning-based resource recommendation system with data structure processing in an illustrative embodiment. It is to be understood that this particular process is only an example, and additional or alternative processes can be carried out in other embodiments.

In this embodiment, the process includes steps 900 through 906. These steps are assumed to be performed by the automated resource-related recommendation system 105 utilizing elements 112, 114, 116 and 118.

Step 900 includes processing, into one or more data structures comprising resource-related task allocation data, information pertaining to at least one resource-related task request for at least one given user. In at least one embodiment, processing information pertaining to at least one resource-related task request for at least one given user includes processing, into the one or more data structures, information related to one or more of user type associated with the at least one given user, resource type associated with the at least one resource-related task request, system type associated with one or more systems relevant to performance of the at least one resource-related task request, geographic information associated with the at least one given user, geographic information associated with the one or more systems, and historical performance data attributed to the one or more systems in connection with resource-related tasks.

Step 902 includes generating filtered data by processing at least a portion of the one or more data structures using one or more machine learning-based filtering techniques. In one or more embodiments, generating filtered data includes predicting one or more preferences of at least one given user based at least in part on one or more preferences of one or more other users requesting resource-related tasks by processing the at least a portion of the one or more data structures using one or more collaborative filtering techniques. In such an embodiment, processing the at least a portion of the one or more data structures using one or more collaborative filtering techniques can include using matrix factorization to decompose at least one interaction matrix from the one or more data structures and identify one or more latent factors, associated with the at least one interaction matrix, that represent one or more relationships between the one or more other users requesting resource-related tasks and one or more systems available for task allocation. Further, in such an embodiment, using matrix factorization to decompose at least one interaction matrix can include using at least one truncated SVD technique to decompose the at least one interaction matrix into the one or more latent factors.

Also, in one or more embodiments, generating filtered data includes determining one or more task-specific attributes for the at least one resource-related task request by processing the at least a portion of the one or more data structures using one or more content-based filtering techniques. Additionally or alternatively, generating filtered data can include processing at least a portion of the one or more data structures using a combination of one or more collaborative filtering techniques and one or more content-based filtering techniques.

Step 904 includes generating at least one system recommendation for allocating the at least one resource-related task request by processing at least a portion of the filtered data. In at least one embodiment, generating at least one system recommendation includes identifying one or more resource-related partner systems to which the at least one resource-related task request for the at least one given user should be allocated.

Step 906 includes performing one or more automated actions based at least in part on the at least one generated system recommendation. In one or more embodiments, performing one or more automated actions comprises automatically allocating the at least one resource-related task request to a system in accordance with the at least one system recommendation. In such an embodiment, performing one or more automated actions comprises automatically initiating, using the system, completion of the at least one resource-related task request. Additionally or alternatively, performing one or more automated actions can include automatically training at least a portion of the one or more machine learning-based filtering techniques based at least in part on feedback related to the at least one generated system recommendation.

Accordingly, the particular processing operations and other functionality described in conjunction with the flow diagram of FIG. 9 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically generate resource-related task allocation recommendations using machine learning techniques. These and other embodiments can effectively overcome problems associated with time-intensive processes which produce sub-optimal or inaccurate user and/or system selections as well as related resource wastage.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

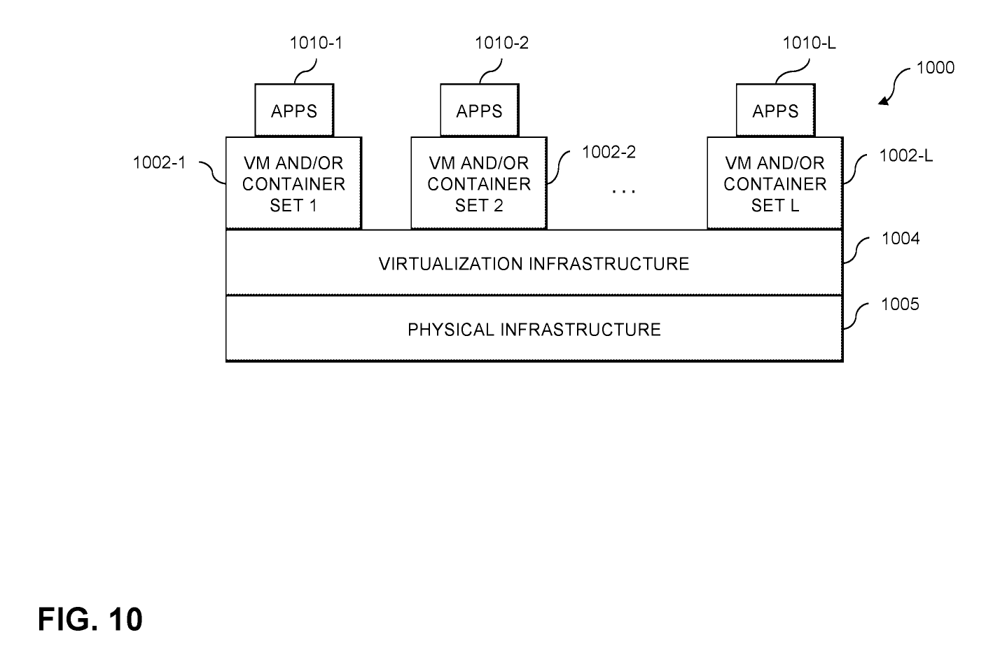

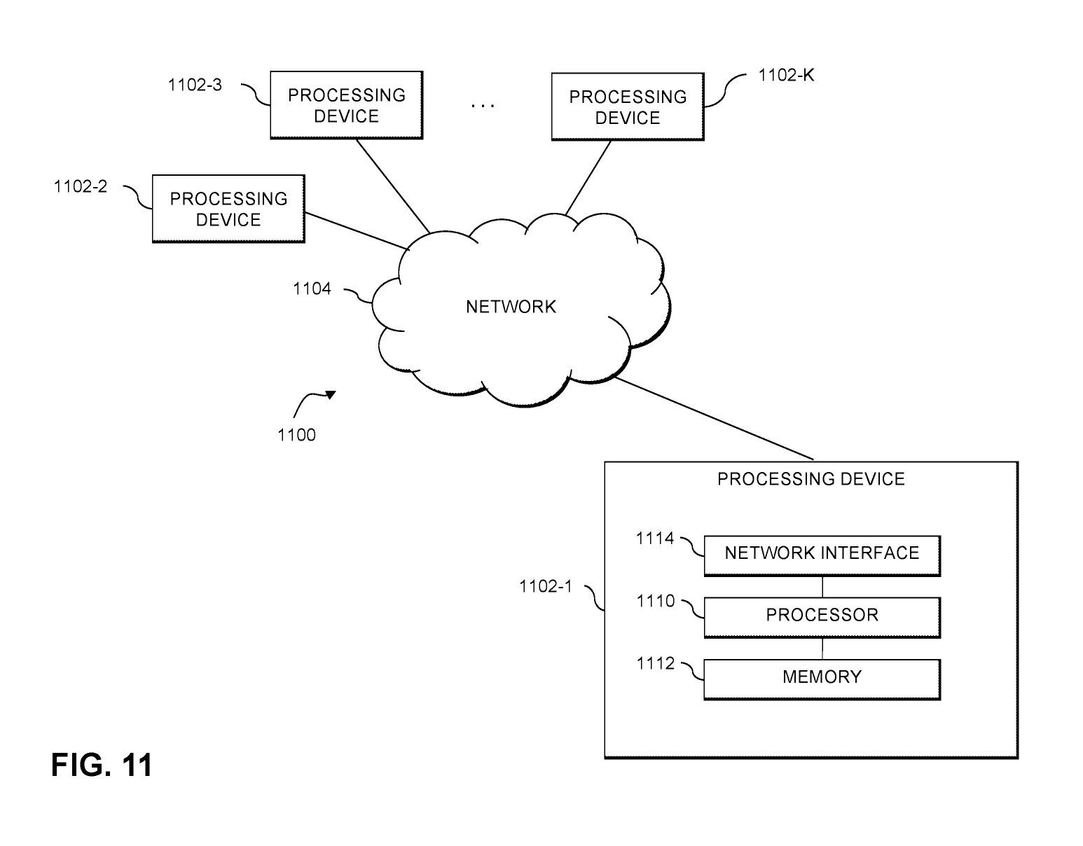

Illustrative embodiments of processing platforms will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that are utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 comprise respective VMs, respective sets of one or more containers, or respective sets of one or more containers running in VMs. In some implementations of the FIG. 10 embodiment, the VMs/container sets 1002 comprise respective VMs implemented using virtualization infrastructure 1004 that comprises at least one hypervisor.

A hypervisor platform may be used to implement a hypervisor within the virtualization infrastructure 1004, wherein the hypervisor platform has an associated virtual infrastructure management system. The underlying physical machines comprise one or more information processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1102-1 in the processing platform 1100 comprises a processor 1110 coupled to a memory 1112.

The processor 1110 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory 1112 comprises RAM, ROM or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
processing, into one or more data structures comprising resource-related task allocation data, information pertaining to at least one resource-related task request for at least one given user;
generating filtered data by processing at least a portion of the one or more data structures using one or more machine learning-based filtering techniques;
generating at least one system recommendation for allocating the at least one resource-related task request by processing at least a portion of the filtered data; and
performing one or more automated actions based at least in part on the at least one generated system recommendation;
wherein the method is performed by at least one processing device comprising a processor coupled to a memory.

2. The computer-implemented method of claim 1, wherein generating filtered data comprises predicting one or more preferences of at least one given user based at least in part on one or more preferences of one or more other users requesting resource-related tasks by processing the at least a portion of the one or more data structures using one or more collaborative filtering techniques.

3. The computer-implemented method of claim 2, wherein processing the at least a portion of the one or more data structures using one or more collaborative filtering techniques comprises using matrix factorization to decompose at least one interaction matrix from the one or more data structures and identify one or more latent factors, associated with the at least one interaction matrix, that represent one or more relationships between the one or more other users requesting resource-related tasks and one or more systems available for task allocation.

4. The computer-implemented method of claim 3, wherein using matrix factorization to decompose at least one interaction matrix comprises using at least one truncated singular value decomposition (SVD) technique to decompose the at least one interaction matrix into the one or more latent factors.

5. The computer-implemented method of claim 1, wherein generating filtered data comprises determining one or more task-specific attributes for the at least one resource-related task request by processing the at least a portion of the one or more data structures using one or more content-based filtering techniques.

6. The computer-implemented method of claim 1, wherein generating filtered data comprises processing at least a portion of the one or more data structures using a combination of one or more collaborative filtering techniques and one or more content-based filtering techniques.

7. The computer-implemented method of claim 1, wherein generating at least one system recommendation comprises identifying one or more resource-related partner systems to which the at least one resource-related task request for the at least one given user should be allocated.

8. The computer-implemented method of claim 1, wherein performing one or more automated actions comprises automatically allocating the at least one resource-related task request to a system in accordance with the at least one system recommendation.

9. The computer-implemented method of claim 8, wherein performing one or more automated actions comprises automatically initiating, using the system, completion of the at least one resource-related task request.

10. The computer-implemented method of claim 1, wherein performing one or more automated actions comprises automatically training at least a portion of the one or more machine learning-based filtering techniques based at least in part on feedback related to the at least one generated system recommendation.

11. The computer-implemented method of claim 1, wherein processing information pertaining to at least one resource-related task request for at least one given user comprises processing, into the one or more data structures, information related to one or more of user type associated with the at least one given user, resource type associated with the at least one resource-related task request, system type associated with one or more systems relevant to performance of the at least one resource-related task request, geographic information associated with the at least one given user, geographic information associated with the one or more systems, and historical performance data attributed to the one or more systems in connection with resource-related tasks.

12. A non-transitory processor-readable storage medium having stored therein program code of one or more software programs, wherein the program code when executed by at least one processing device causes the at least one processing device:
to process, into one or more data structures comprising resource-related task allocation data, information pertaining to at least one resource-related task request for at least one given user;
to generate filtered data by processing at least a portion of the one or more data structures using one or more machine learning-based filtering techniques;
to generate at least one system recommendation for allocating the at least one resource-related task request by processing at least a portion of the filtered data; and
to perform one or more automated actions based at least in part on the at least one generated system recommendation.

13. The non-transitory processor-readable storage medium of claim 12, wherein generating filtered data comprises predicting one or more preferences of at least one given user based at least in part on one or more preferences of one or more other users requesting resource-related tasks by processing the at least a portion of the one or more data structures using one or more collaborative filtering techniques.

14. The non-transitory processor-readable storage medium of claim 13, wherein processing the at least a portion of the one or more data structures using one or more collaborative filtering techniques comprises using matrix factorization to decompose at least one interaction matrix from the one or more data structures and identify one or more latent factors, associated with the at least one interaction matrix, that represent one or more relationships between the one or more other users requesting resource-related tasks and one or more systems available for task allocation.

15. The non-transitory processor-readable storage medium of claim 12, wherein generating filtered data comprises determining one or more task-specific attributes for the at least one resource-related task request by processing the at least a portion of the one or more data structures using one or more content-based filtering techniques.

16. The non-transitory processor-readable storage medium of claim 12, wherein generating filtered data comprises processing at least a portion of the one or more data structures using a combination of one or more collaborative filtering techniques and one or more content-based filtering techniques.

17. An apparatus comprising:
at least one processing device comprising a processor coupled to a memory;
the at least one processing device being configured:
to process, into one or more data structures comprising resource-related task allocation data, information pertaining to at least one resource-related task request for at least one given user;
to generate filtered data by processing at least a portion of the one or more data structures using one or more machine learning-based filtering techniques;
to generate at least one system recommendation for allocating the at least one resource-related task request by processing at least a portion of the filtered data; and
to perform one or more automated actions based at least in part on the at least one generated system recommendation.

18. The apparatus of claim 17, wherein generating filtered data comprises predicting one or more preferences of at least one given user based at least in part on one or more preferences of one or more other users requesting resource-related tasks by processing the at least a portion of the one or more data structures using one or more collaborative filtering techniques.

19. The apparatus of claim 18, wherein processing the at least a portion of the one or more data structures using one or more collaborative filtering techniques comprises using matrix factorization to decompose at least one interaction matrix from the one or more data structures and identify one or more latent factors, associated with the at least one interaction matrix, that represent one or more relationships between the one or more other users requesting resource-related tasks and one or more systems available for task allocation.

20. The apparatus of claim 17, wherein generating filtered data comprises determining one or more task-specific attributes for the at least one resource-related task request by processing the at least a portion of the one or more data structures using one or more content-based filtering techniques.
